(19) United States
(12) Patent Application Publication
(10) Pub. No.: US 2009/0021842 A1
(43) Pub. Date: Jan. 22, 2009

(54) METHOD OF MANUFACTURING AN ELECTROWETTING-BASED VARIABLE-FOCUS LENS

(75) Inventors: Bruno Berge, Lyon (FR); Jerome Peseux, Solaize (FR); Bertrand Boutaud, Lyon (FR); Pierre Craen, Lyon (FR)

Correspondence Address: OSHA LIANG L.L.P., TWO HOUSTON CENTER, 909 FANNIN, SUITE 3500, HOUSTON, TX, 77010, US

(73) Assignee: Varioptic S.A.

(21) Appl. No.: 11/993,144

(22) PCT Filed: Jun. 23, 2006
(86) PCT No.: PCT/EP06/63524

§ 371 Date: Dec. 19, 2007

(30) Foreign Application Priority Data
Jun. 23, 2005 (FR) 0551736

(51) Int. Cl. G02B 3/14

(52) U.S. Cl. 359/666; 264/1.32

(57) ABSTRACT

The present invention relates to a method of manufacturing an electrowetting-based variable-focus lens, comprising: (a) providing an enclosure having a cavity (17) and at least one channel (27, 28; 59) communicating at one end with the cavity and at the other end emerging at the exterior surface of the lens; (b) filling the cavity with first and second liquids (44, 47) that are immiscible and of different refractive indices via the channel; and (c) hermetically scaling the channel.

### FIELD OF THE INVENTION

The present invention relates to a method of manufacturing a variable-focus lens and more particularly to a method of manufacturing a lens involving the deformation of a drop of liquid by electrowetting effects. The present invention also relates to an electrowetting-based variable-focus lens obtained by such a method.

### SUMMARY OF THE PRIOR ART

A variable-focus lens comprises an enclosure, generally bounded by two transparent parallel plates, which contains at least two immiscible liquids of different refractive indices. In general, one of the liquids is an aqueous liquid and the other liquid is an oily liquid. The interface between the two liquids defines a movable refractive interface through which the light rays received by the lens pass. The lens comprises means for deforming the movable dioptric interface by electrowetting effects, thus making it possible to modify the optical power of the lens.

Such electrowetting-based variable-focus lenses are described in general in European patent 1 019 758.

The filling of the lens with the two liquids is generally carried out when one of the transparent plates has not yet been fastened to the enclosure. The enclosure is then immersed in the aqueous liquid, which fills the entire enclosure. A drop of oily liquid can then be put into place, for example by means of a syringe. The transparent plate is then fitted in order to close off the enclosure.

With such a method of assembly, it may be difficult for the position of the drop of the oily liquid in the enclosure of the aqueous-liquid-filled lens to be accurately controlled. Furthermore, when closing off the enclosure of the lens, it may be difficult for the internal pressure of the lens to be accurately controlled. This is because the step of closing off the enclosure of the lens generally comprises a step of compressing a seal. At the end of the method of assembling the lens, there is therefore an overpressure in the lens that cannot be easily controlled accurately. For some applications, it may be desirable to accurately fix the internal pressure of the lens at the end of assembly. In particular, it may be desirable for the internal pressure of the lens to be fixed at a value lower than atmospheric pressure.

### SUMMARY OF THE INVENTION

The aim of the present invention is to provide a method of manufacturing an electrowetting-based variable-focus lens that allows simple and precise positioning of the liquids contained in the lens, and also an electrowetting-based variable-focus lens obtained by such a method.

Another object of the present invention is to allow the internal pressure of the lens when assembling the lens to be fixed in a simple and precise manner.

For this purpose, according to a first aspect of the present invention there is provided a method of manufacturing an electrowetting-based variable-focus lens, which comprises the following steps of:
(a) providing an enclosure having a cavity and at least one channel communicating at one end with the cavity and at the other end emerging at the exterior surface of the lens;
(b) filling the cavity with first and second liquids that are immiscible and of different refractive indices via the channel; and
(c) hermetically sealing the channel.

According to one example of a method according to the present invention, the lens comprises first and second channels, each of the first and second channels communicating at one end with the cavity and at the other end emerging at the external surface of the lens. The method comprises the following successive steps of: introducing the first liquid via the first channel, in order to at least partly fill the cavity; introducing the second liquid via the first or the second channel until the cavity is completely filled with the first and second liquid; and hermetically sealing the first and second channels.

According to a further example of a method according to the present invention, step (b) comprises the steps of creating a vacuum in the cavity; and introducing in succession by suction, the first and second liquids via the channel in order to fill the cavity.

According to a further example of a method according to the present invention, step (c) comprises the steps of hermetically sealing the channel with a malleable material; and holding the malleable material in place by an adhesive.

According to a further example of a method according to the present invention, step (c) comprises the steps of applying an overpressure to the enclosure; partially filling the channel with a curable liquid material, in other words a liquid material capable of hardening; in releasing the overpressure applied to the enclosure, which results in the curable liquid material penetrating further into the channel; and hardening the curable liquid material.

According to a further example of a method according to the present invention, step (c) comprises the steps of heating the enclosure; partially filling the channel with a curable liquid material; cooling the enclosure, which results in the curable liquid material penetrating further into the channel; and hardening the curable liquid material.

According to one example of a method according to the present invention, step (c) is preceded by a step of forming, via the channel, a gas bubble in contact with the first liquid in a region that is not liable to be traversed by light rays passing through the lens.

According to a further aspect of the present invention, there is provided an electrowetting-based variable-focus lens comprising an enclosure that comprises a cavity containing at least two immiscible liquids of different refractive indices. The enclosure comprises at least one channel communicating at one end with the cavity and at the other end emerging at the exterior surface of the lens, said channel being hermetically sealed by a plug.

According to one embodiment of the present invention, the lens comprises at least two channels, each channel communicating at one end with the cavity and at the other end emerging at the external surface of the enclosure, each channel being hermetically sealed by a plug, said cavity being bounded by first and second transparent plates opposite each other and by an intermediate component, one channel communicating with the cavity at the join between the first plate and the intermediate component and the other channel communicating with the cavity at the join between the second plate and the intermediate component.

According to one embodiment of the present invention, the channel comprises a portion of reduced cross-section, the plug comprising at least one part made of a malleable material compressed in said portion of reduced cross-section.

According to one embodiment of the present invention, the plug comprises at least one part made of an adhesive.

According to one embodiment of the present invention, the lens further comprises a chamber containing one liquid from among the two liquids and a gas bubble, a means for said one liquid to pass between the chamber and the cavity, and a means for retaining the gas bubble in the chamber.

### BRIEF DESCRIPTION OF THE DRAWINGS

These objects, features and advantages, together with others of the present invention, will be explained in detail in the following description of non-limiting specific exemplary embodiments in relation to the appended figures in which:

FIG. 1 is an exploded sectional view of a first exemplary embodiment of a variable-focus lens according to the invention;

FIGS. 2 to 4 illustrate successive steps of one example of a method of assembling the lens of FIG. 1; and

FIG. 5 is a partial cross-section of a second exemplary embodiment of the variable-focus lens according to the invention.

### DETAILED DESCRIPTION

For the sake of clarity, identical elements have been denoted by identical references in the various figures.

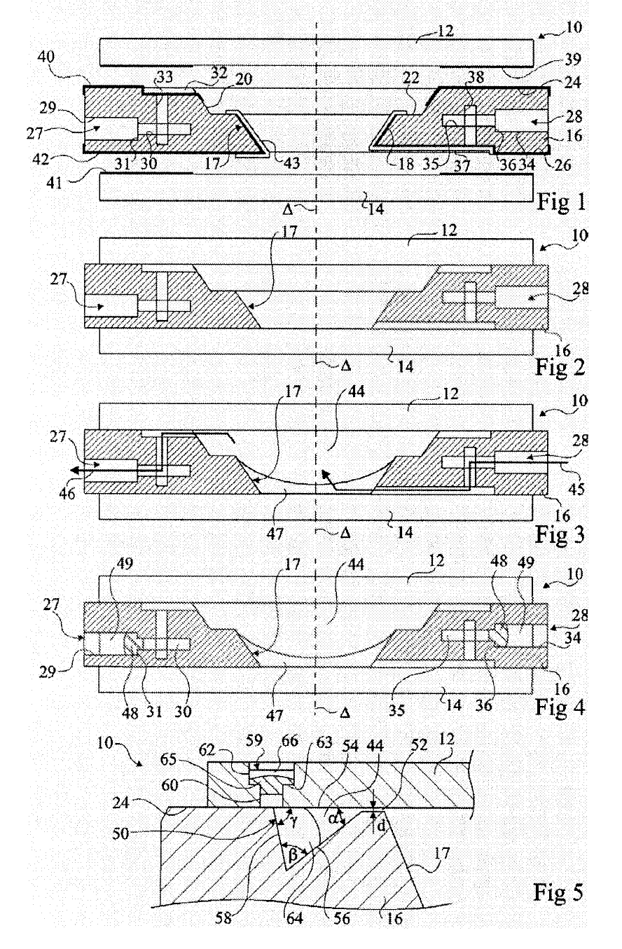

FIG. 1 is a sectional exploded view of a first exemplary embodiment of a variable-focus lens 10 according to the invention, comprising upper and lower circular transparent plates 12 and 14 of axis Δ and an annular ring 16 of axis A. The ring 16 has a central opening 17 which is bounded by a lower truncated-cone-shaped wall 18 (in other words a conical frustum) and an upper truncated-cone-shaped wall 20 that are separated by a shoulder 22. The ring 16 further comprises, on its upper surface, a planar face 24 on which the upper plate 12 is intended to bear, in order to form the topside of an enclosure. Similarly, the ring 16 comprises, on its lower face, a planar bearing surface 26 on which the lower plate 14 is intended to bear, in order to form the underside of the enclosure. The plates 12 and 14 and the ring 16 may be made of rigid insulating materials, for example glass in the case of plates 12, 14, which must be transparent to the intended operating wavelengths of the lens, and a ceramic material, for example alumina, in the case of the ring 16.

The ring 16 comprises channels 27, 28 which each connect the central opening 17 with the side wall of the ring 16. In the present exemplary embodiment, the channel 27 comprises a cylindrical opening 29, the axis of which is perpendicular to the axis A and one end of which opens into the side wall of the ring 16. The opening 29 is extended by a cylindrical opening 30 with a closed end of the same axis and of smaller diameter, defining a shoulder 31 with the opening 29. The ring comprises a groove 32 on the upper face 24 of the ring 16, which has one end opening into the upper truncated conical wall 20 of the central opening 17 and a closed end. The ring 16 further comprises an opening 33 with a closed end of axis parallel to the axis A, which opens into the groove 32 and communicates with the opening 30. In the present exemplary embodiment, the channel 28 has a structure substantially similar to the structure of the channel 27. The channel 28 comprises a cylindrical opening 34, the axis of which is perpendicular to the axis A and one end of which opens into the side wall of the ring 16. The opening 34 is extended by a cylindrical opening 35 with a closed end of the same axis and of smaller diameter and which, with the opening 34, defines a shoulder 36. The ring 16 comprises a groove 37 on the lower face 26 of the ring 16, which has one end opening into the lower truncated conical wall 18 of the central opening 17 and a closed end. The ring 16 further comprises an opening 38 with a closed end of axis parallel to the axis A, which opens into the groove 37 and communicates with the opening 35.

More generally, the channels 27, 28 may be of any shape. However, it is desirable for the region where each channel 27, 28 opens into the central opening 27 to be placed so as not to disturb the operation of the lens 10.

The external periphery of the lower face of the upper plate 12 is coated with a conducting film 39. Conducting film 40 is also deposited on the planar face 24, that film extending towards the external periphery of the ring 16 and being extended towards the internal periphery as far as level with the upper truncated conical portion 20. In FIG. 1, the film 40 is shown covering the walls of the groove 32. The conducting film 40 is intended to come into contact with the conducting film 39. The conducting film 40 extends sufficiently to come into contact via its internal part with the conducting liquid that will be contained in the lens. The conducting films 39 and 40 are made of materials that are electrically conducting sufficiently to act as electrodes and adhere, on one side, to the plate 12 and, on the other side, to the ring 16. These materials may for example be a gold-tin alloy, an indium-based alloy, a bismuth-based alloy, etc.

The upper face of the lower plate 14 is coated with a conducting film 41 on its external periphery facing the bearing surface 26 of the lower face of the ring 16. The lower face of the ring 16 is coated with a conducting film 42 which is extended over the lower truncated conical portion 18. In FIG. 1, the film 42 is shown covering the walls of the groove 37. On the lower truncated conical wall 18, the conducting film 42 is coated with an insulating film 43 that is extended slightly onto the shoulder 22 and onto the lower face of the ring 16, penetrating into the groove 37. The materials making up the conducting films 41 and 42 are of the same nature as the materials of the conducting films 39 and 40. The electrodes of the lens 10 correspond to the conducting films 40 and 42. The films 49, 40, 41, 42 and 43 are shown only in FIG. 1 and have not been drawn to scale.

FIG. 2 shows the structure obtained after the ring 16 has been fastened to the upper and lower plates 12 and 14. The bonding between each plate 12, 14 and the ring 16 may be provided by localized heating of the periphery of the structure. In one particular exemplary embodiment of the present invention, this may be produced by heating the periphery of the ring 16 by laser irradiation. The conducting films 39, 40, 41 and 42 then melt and form an impermeable bond. In an alternative embodiment, the conducting films 39 and 41 may be omitted, it being possible for the upper and lower plates 12, 14 to be fastened to the ring 16 by means of an adhesive.

FIG. 3 illustrates the step of the method of filling the lens 10 with the conducting and insulating liquids. Such a step firstly comprises the filling of the lens 10 with the conducting liquid 44. To do this, the conducting liquid is introduced via the channel 28 (along the path 45), the channel 27 then acting as a vent. The conducting liquid is introduced until it completely fills the central opening 17 and escapes via the channel 27 (along the path 46). The insulating liquid is then introduced via the channel 28 (along the path 45) until a drop 47 is obtained on the truncated conical wall 18. When no voltage is applied between the electrodes 40 and 42, the refractive optical interface separating the insulating liquid 47 from the conducting liquid 44 is level with the upper part of the truncated conical wall 18.

FIG. 4 shows the structure obtained after the channels 27, 28 have been closed off by means of balls 48 of a malleable material, for example gold. The balls 48 are squashed into the shoulders 31, 36 so as to close off the openings 30, 35. The balls 48 are held in place by depositing an adhesive 49, for example an epoxy adhesive, in the openings 29, 34. The squashed balls 48 ensure that the lens 10 is sealed and the adhesive 49 provides mechanical retention of the squashed balls 48. The hermetic sealing of the channels 27, 28 is achieved after the internal pressure in the lens 10 has been set to a desired value.

According to an alternative example of a method according to the present invention, once the lens 10 has been filled with the conducting and insulating liquids the channels 27, 28 are closed off in the following manner:
the lens 10 is pressurized, for example by applying pressure to the upper and lower plates 12, 14;
the openings 29, 34 are filled with a liquid adhesive, for example an epoxy adhesive that can be cured by being exposed to ultraviolet radiation, which is compatible with the insulating and conducting liquids, i.e. immiscible with the insulating and conducting liquids;
the pressure applied to the lens 10 is released so that the liquid adhesive penetrates into the openings 30, 35 by suction; and
the adhesive is cured, for example by exposing the adhesive to a source of ultraviolet radiation.

According to another alternative example of a method according to the present invention, once the lens 10 has been filled with the conducting and insulating liquids the channels 27, 28 are closed off in the following manner:
the temperature of the lens 10 is raised, causing the liquids contained in the lens to expand;
the openings 29, 34 are filled with a liquid adhesive, for example an epoxy adhesive that can be cured by being exposed to ultraviolet radiation, which is compatible with the insulating and conducting liquids, i.e. immiscible with the insulating and conducting liquid;
the lens 10 is cooled so that the liquid adhesive penetrates into the openings 30, 35 by suction resulting from the reduction in the volume of the liquids contained in the lens 10; and
the adhesive is cured, for example by exposing the adhesive to a source of ultraviolet radiation.

In general, the channels 27, 28 may be closed off with any material that is compatible with the insulating and conducting liquids and allows a sealed closure of the channels to be obtained.

In the present exemplary embodiment, both channels 27, 28 are made in the ring 16. According to an alternative embodiment, provision may be made for at least one of the channels 27, 28 to be made partly in the ring 16 and partly in one of the upper and lower plates 12, 14. For example, it is possible to provide, for one channel, an opening in the periphery of a plate 12, 14, which opens into a groove provided in the ring 16 and connected to the central opening 17. Such an opening can then be closed off as described above, especially by squashing a gold ball into the opening. According to another alternative embodiment, the channels 27, 28 may both be in the plates 12, 14 and open into regions of the central opening 17 so as to cause little or no disturbance to the path of the light rays.

According to an alternative embodiment, the lens comprises a single channel, for example the channel 28 of the exemplary embodiment described above. The lens can then be filled in the following manner:
a vacuum is created in the internal volume of the lens 10;
the internal volume of the lens is partially filled with the conducting liquid, by introducing conducting liquid into the channel, the lens filling by sucking up the conducting liquid;
the drop of insulating liquid is formed by completing the filling of the internal volume of the lens, by introducing the insulating liquid into the channel, the lens filling by sucking up the insulating liquid; and
the channel is closed off.

In an alternative example of a method according to the present invention, a gas bubble is intentionally introduced so as to come into contact with one of the liquids contained in the lens, taking care to prevent the gas bubble from being present in the region through which the light rays pass. When the temperature changes, the liquids contained in the lens expand at the expense of the gas bubble, which by nature is highly compressible, thus limiting the change in internal pressure of the lens. The gas may be air, an inert gas or a mixture of inert gases or the vapour of one of the liquids contained in the lens.

FIG. 5 is a detailed sectional view of a second exemplary embodiment allowing the formation of a gas bubble in the lens. The ring 16 comprises, on the upper face 24, a circular groove 50 about the axis a of the lens 10, which groove is connected to the central opening of the ring 16 via an annular interstice 52 of thickness d along the axis A. The groove 50 is bounded by an upper wall 54 corresponding to a portion of the lower wall of the upper plate 12, a lower wall 56 inclined to the upper wall 54 at an angle Δ, and an end wall 58 inclined to the lower wall 56 at an angle β and to the upper wall 54 at an angle γ, the lower wall 56 and the end wall 58 corresponding to portions of the upper wall of the ring 16. Preferably, the thickness d of the interstice is less than a few tens of microns. The interstice 52 need not have a constant thickness, and can be obtained by the upper plate 12 simply pressing on the annular ring 16, the surface irregularities of the plate 12 and of the annular ring 16 being sufficient to ensure the presence of communicating channels between the groove 50 and the central opening of the ring 16.

The upper plate 12 comprises a channel 59 that connects the groove 50 to the upper face of the upper plate 12. The channel 59 comprises an opening 60, the axis of which is parallel to the axis A and one end of which opens into the groove 50. The opening 60 is extended by a larger-diameter cylindrical opening 62 with which it defines a shoulder 63. The opening 62 opens into the upper face of the upper plate 12. According to the second exemplary embodiment, the channel 59 acts as the channel 27. The lens 10 further comprises the channel 28 described previously in relation to the first exemplary embodiment.

After the lens 10 has been filled, a gas may be introduced into the groove 50 so that a gas bubble 64 forms in the groove 50. This may be achieved by sucking in liquid via the channel 28. After the air bubble has been formed, the channel 59 is hermetically sealed, for example as described previously by means of a squashed gold ball 65 and a plug of adhesive 66. According to a variant of the second exemplary embodiment, the channel 27 is present, the groove 50 being locally interrupted on either side of the groove 32 of the channel 27. The channels 27 and 28 can then be used for filling the lens 10, while the channel 59 and one or other of the channels 27 and 28 are used to form the gas bubble 64.

The walls that define the interstice 52 are covered with a hydrophilic material so that the capillary forces prevent the gas bubble 64 from passing into the annular interstice 52. The angle α is smaller than the angles β and γ so that the aqueous liquid is spontaneously attracted into the corner of angle α and the gas bubble 64 is pushed back against the end wall 58. So as to make it even easier to position the gas bubble 64 on the end wall 58, the upper and lower walls 54, 56 may be covered with a hydrophilic material and the end wall 58 may be covered with a hydrophobic material.

Of course, the present invention is capable of various alternative embodiments and modifications that will be apparent to those skilled in the art. In particular, in the exemplary embodiments described above, the lower truncated conical wall 18 may be extended, in the lower part, by a cylindrical wall. Furthermore, in the second exemplary embodiment, the circular groove 50 may be replaced with a spiralled groove, one end of which opens into the central opening 17 and the opposite end of which is closed.

1. Method of manufacturing an electrowetting-based variable-focus lens, comprising:
(a) providing an enclosure having a cavity (17) and at least one channel (27, 28; 59) communicating at one end with the cavity and at the other end emerging at the exterior surface of the lens;
(b) filling the cavity with first and second liquids (44, 47) that are immiscible and of different refractive indices via the channel; and
(c) hermetically sealing the channel.

2. Method according to claim 1, in which the lens (10) comprises first and second channels (27, 28; 59), each of the first and second channels communicating at one end with the cavity and at the other end emerging at the exterior surface of the lens, which method comprises:
introducing the first liquid (44) via the first channel (27), in order to at least partly fill the cavity (17);
introducing the second liquid (47) via the first or the second channel (27, 28; 59) until the cavity is completely filled with the first and second liquid; and
hermetically sealing the first and second channels.

3. Method according to claim 1, in which step (b) comprises the following steps:
creating a vacuum in the cavity (17); and
introducing in succession by suction, the first and second liquids (44, 47) via the channel in order to fill the cavity.

4. Method according to claim 1, in which step (c) comprises the following steps:
hermetically sealing the channel (27, 28; 59) with a malleable material (48; 65); and
holding the malleable material in place by an adhesive (49; 66).

5. Method according to claim 1, in which step (c) comprises the following steps:
applying an overpressure to the enclosure;
partially filling the channel (27, 28) with a curable liquid material;
releasing the overpressure applied to the enclosure, which results in the curable liquid material penetrating further into the channel; and
hardening the curable liquid material.

6. Method according to claim 1, in which step (c) comprises the following steps:
heating the enclosure;
partially filling the channel (27, 28) with a curable liquid material;
cooling the enclosure, which results in the curable liquid material penetrating further into the channel; and
hardening the curable liquid material.

7. Method according to claim 1, in which step (c) is preceded by a step comprising forming, via the channel (27, 28; 59), a gas bubble (64) in contact with the first liquid in a region that is not liable to be traversed by light rays passing through the lens.

8. Electrowetting-based variable-focus lens (10) comprising an enclosure that comprises a cavity (17) containing at least two immiscible liquids (44, 47) of different refractive indices, wherein the enclosure comprises at least one channel (27, 28; 59) communicating at one end with the cavity and at the other end emerging at the exterior surface of the lens, said channel being hermetically sealed by a plug (48, 49; 65, 66).

9. Lens according to claim 8, which comprises at least two channels (27, 28; 59), each channel communicating at one end with the cavity and at the other end emerging at the exterior surface of the lens, each channel being hermetically sealed by a plug (48, 49; 65, 66), said cavity (17) being bounded by first and second transparent plates (12, 14) opposite each other and by an intermediate component (16), one channel (27) communicating with the cavity at the join between the first plate and the intermediate component and the other channel (28) communicating with the cavity at the join between the second plate and the intermediate component.

10. Lens according to claim 8, in which the channel comprises a portion (31, 36; 63) of reduced cross-section, the plug (48, 49; 65, 66) comprising at least one part (48; 65) made of a malleable material compressed in said portion of reduced cross-section.

11. Lens according to claim 8, in which the plug (48, 49; 65, 66) comprises at least one part (49, 66) made of an adhesive.

12. Lens according to claim 8, which further comprises a chamber (50) containing one liquid (44) from among the two liquids and a gas bubble (64), a means (52) for said one liquid to pass between the chamber and the cavity (17), and a means for retaining the gas bubble in the chamber.
